(19) United States
(12) Patent Application Publication
(10) Pub. No.: US 2022/0215001 A1
(43) Pub. Date: Jul. 7, 2022

(54) REPLACING DEDICATED WITNESS NODE IN A STRETCHED CLUSTER WITH DISTRIBUTED MANAGEMENT CONTROLLERS

(71) Applicant: Dell Products L.P., Round Rock, TX (US)

(72) Inventors: Vinod P S, Bangalore (IN); Krishnaprasad K, Bengaluru (IN); Robin MATHEW, Bangalore (IN)

(73) Assignee: Dell Products L.P., Round Rock, TX (US)

(21) Appl. No.: 17/143,753

(22) Filed: Jan. 7, 2021

(51) Int. Cl. G06F 16/182; G06F 16/28; G06F 9/455

(52) U.S. Cl. CPC G06F 16/182; G06F 9/45558; G06F 16/285

(57) ABSTRACT

An information handling system cluster may include a first site located at a first geographical location and comprising a set of first management controllers, and a second site located at a second geographical location and comprising a set of second management controllers. The information handling system cluster may be configured to provide software-defined storage based on physical storage resources at the first site and the second site. The information handling system cluster may be further configured to execute a cluster management system configured to select individual ones of the set of first management controllers and the set of second management controllers to act as distributed witness nodes for the information handling system cluster.

### TECHNICAL FIELD

The present disclosure relates in general to information handling systems, and more particularly to management of clusters of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

For purposes of clarity and exposition, this disclosure will discuss the example of vSAN in detail. One of ordinary skill in the art with the benefit of this disclosure will understand its applicability to other systems, however.

vSAN allows for the creation of a “stretched cluster,” which creates a storage system that spans between multiple geographically separated sites, synchronously replicating data between sites. This feature allows for an entire site failure to be tolerated. A vSAN stretched cluster may use a dedicated a witness node in another site to provide the features it offers.

For example, a stretched cluster may implement distributed RAID 6 (or another RAID level as desired) to provide data protection. The stretched cluster may also be used to prevent downtime when a full site failure occurs. The contents of the stretched cluster may thus be mirrored from one site to another

As one example, stretched clusters may use “heart beats” to detect site failures. Heart beats may be sent between a master node and a backup node, between a master node and a witness node, and/or between a witness node and a backup node.

Having a dedicated witness node may pose challenges, however. It may involve additional costs, such as deployment of the dedicated witness node, its network, other related infrastructure needs, licenses, maintenance efforts and complexities associated with them, etc. Embodiments of this disclosure may thus allow for one or more distributed management controllers to carry out functionalities that would otherwise rely on a dedicated witness node.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with the management of clusters of information handling systems may be reduced or eliminated.

In accordance with embodiments of the present disclosure, an information handling system cluster may include a first site located at a first geographical location and comprising a set of first management controllers, and a second site located at a second geographical location and comprising a set of second management controllers. The information handling system cluster may be configured to provide software-defined storage based on physical storage resources at the first site and the second site. The information handling system cluster may be further configured to execute a cluster management system configured to select individual ones of the set of first management controllers and the set of second management controllers to act as distributed witness nodes for the information handling system cluster.

In accordance with these and other embodiments of the present disclosure, a method may include executing a cluster management system at an information handling system cluster that includes: a first site located at a first geographical location and comprising a set of first management controllers; and a second site located at a second geographical location and comprising a set of second management controllers. The information handling system cluster may be configured to provide software-defined storage based on physical storage resources at the first site and the second site. The cluster management system may be configured to select individual ones of the set of first management controllers and the set of second management controllers to act as distributed witness nodes for the information handling system cluster.

In accordance with these and other embodiments of the present disclosure, an article of manufacture may include a non-transitory, computer-readable medium having computer-executable instructions thereon that are executable by a processor of an information handling system for executing a cluster management system at an information handling system cluster that includes: a first site located at a first geographical location and comprising a set of first management controllers; and a second site located at a second geographical location and comprising a set of second management controllers. The information handling system cluster may be configured to provide software-defined storage based on physical storage resources at the first site and the second site. The cluster management system may be configured to select individual ones of the set of first management controllers and the set of second management controllers to act as distributed witness nodes for the information handling system cluster.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example cluster architecture, in accordance with embodiments of the present disclosure; and

FIG. 3 illustrates a block diagram of an example method, in accordance with embodiments of the present disclosure.

### DETAILED DESCRIPTION

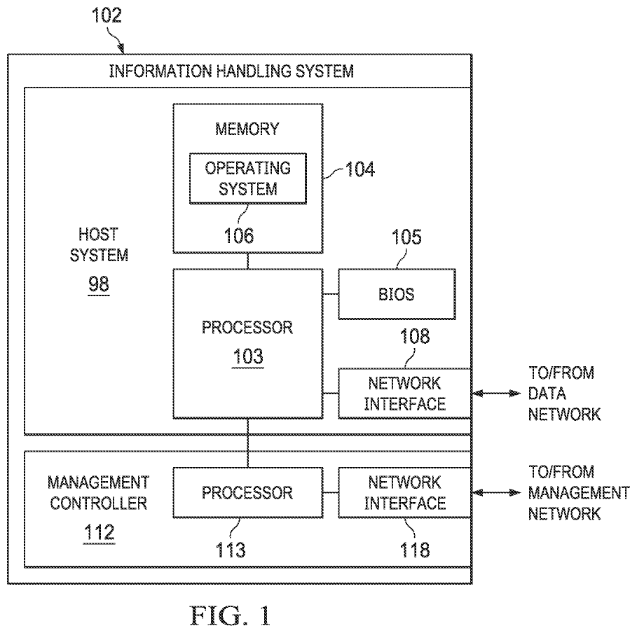

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

Information handling systems such as information handling system 102 may be used to implement a geographically distributed storage system such as an SDS stretched cluster. For example, a first group of one or more information handling systems 102 at a first site and a second group of one or more information handling systems 102 at a second site may form such a stretched cluster. As discussed above, such a cluster may include a dedicated witness node at a third site.

Embodiments of this disclosure may allow for the cluster to function without such a dedicated witness node at the third site. In particular embodiments, an intelligent mechanism may allow for the use of management controller(s) of participating hosts in the stretched cluster, dynamically delegating the responsibilities of the witness node to such management controllers (e.g., based on their available bandwidth).

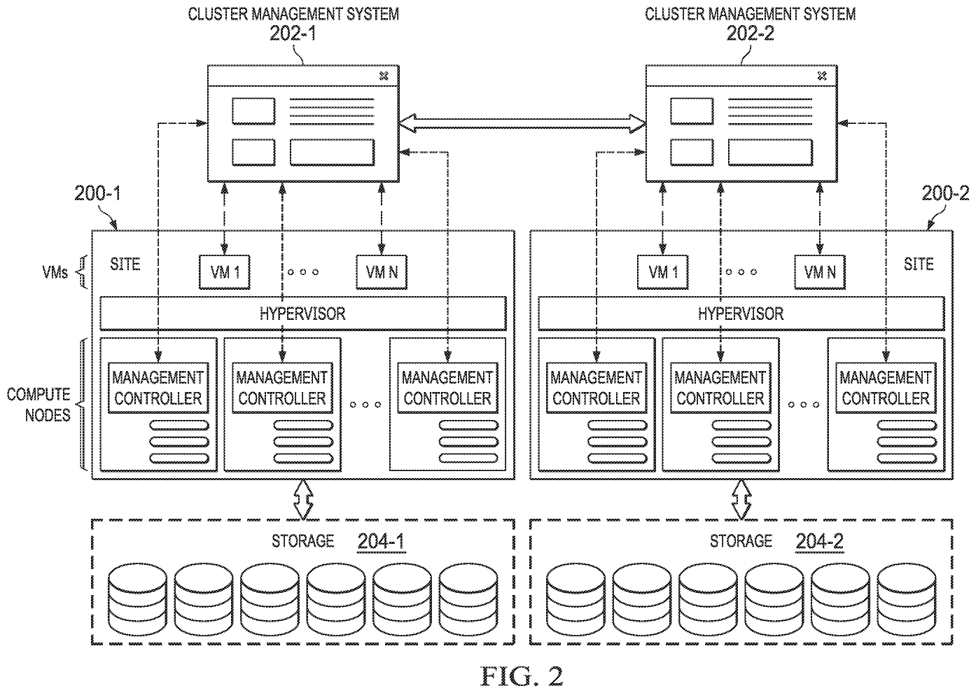

Turning now to FIG. 2, an example of such a stretched cluster is shown. A first site 200-1 includes a cluster management system 202-1, various VMs, a hypervisor, compute nodes each including management controllers, and a storage subsystem 204-1. Similarly, a second site 200-2 includes a cluster management system 202-2, various VMs, a hypervisor, compute nodes each including management controllers, and a storage subsystem 204-2.

For example, at each site the cluster management system (e.g., vCenter® in some embodiments) may create a group of all management controllers of participating hosts. The cluster management system may subscribe to updates on the bandwidth availability of all the participating management controllers such that it receives information regarding changing bandwidth conditions.

Each of these management controllers may execute a Dynamic Bandwidth Availability Monitoring (DBAM) service, which may update the cluster management system regarding the bandwidth availability of each respective management controller at a desired frequency (e.g., once per second, once per minute, once per hour, once per day, etc.).

The cluster management system may maintain a table (or other suitable data structure) as shown below at Table 1 which has the latest details of all participating management controllers. When there is an object-related operation in the cluster requiring a witness node, the cluster management system may examine this table and decide the best management controller that can satisfy the responsibility of witness node.

In the example of a vSAN cluster, a service such as CMMDS (Cluster Monitoring, Membership, and Directory Service) along with a vCenter service (vpxd) may decide the appropriate management controller to hand over the witness responsibilities to for the objects to be created. In other types of clusters, different corresponding services may also be used. The cluster management system may also have an option for the user to configure custom parameters to be considered when selecting the most suitable management controller to run the witness job.

In the case of a node failure, the respective management controller may be removed from the group, and a new management controller may be enrolled into the group (e.g., when the failed system is replaced).

The cluster management system may maintain the information about management controllers participating in the cluster group as shown below at Table 1:

TABLE 1

| | | | | | User | |
|---|---|---|---|---|---|---|
| Mgmt. | | | | | configured | |
| Cntrlr. | | | | Available | parameter | |
| No. | IP | Host | Host IP | Bandwidth | data | . . . |
| 1 | x.x.x.x | 1 | x.x.x.x | 42% | xxx | . . . |
| 2 | x.x.x.x | 2 | x.x.x.x | 14% | xxx | . . . |
| . . . | . . . | . . . | . . . | . . . | . . . | . . . |
| n | x.x.x.x | n | x.x.x.x | 67% | xxx | . . . |

Thus embodiments of this disclosure may provide an intelligent stretched cluster solution using distributed management controllers of participating hosts. Cluster management systems at redundant sites may have the control of all participating hosts and their respective management controllers. The cluster management systems may create a group of all management controllers of the participating hosts in both (or all) of the sites. The cluster management system along with CMMDS may allocate a certain amount (e.g., a configurable amount) of storage space from a software-defined storage to be used to store the witness node metadata. A DBAM service running on each of these management controllers may monitor the bandwidth of the respective management controller and report it to the cluster management system at desired intervals.

A management controller may monitor the virtual machine kernel port group through a USB NIC interface by having a custom plug-in in an HCI management system such as ESXi, or a custom driver or software agent in case the management controller is in a different subnet. The management controller may execute the witness responsibilities with the help of a custom plug-in in the HCI management system or a custom driver through a USB NIC, and the witness metadata may be stored in the storage space that has been pre-allocated.

When a site failure is detected (e.g., via heart beats) the secondary site may take over control and continue to run virtual machines, applications, and related processes to ensure high availability. If the failed site becomes operational again immediately, then the incomplete jobs may be resumed, and data may be synced. But if the site becomes operational after a threshold period (e.g., 60 minutes), then the site may go through a complete rebuild.

According to some embodiments, it may be possible to ensure at least 50% component availability in the event of a host or site failure in a stretched cluster. A witness management controller may store any necessary cluster metadata in software-defined storage as an object in the same site that the management controller resides in, and a redundant copy (e.g., RAID 1 or some other redundancy level if desired) in another site to protect it against host and site failure, and to ensure more than 50% component availability at any point in time-including normal operation, site failure, cluster partitioning (e.g., loss of connectivity/“split brain” scenario), etc. When a stretched cluster is created, a storage space may be allocated to store the metadata in the software defined storage by CMMDS.

As per the cluster architecture, CMMDS may store object metadata information, such as policy-related information on an in-memory database. CMMDS may query a witness management controller to determine the location in which the metadata should be stored. (Because software-defined storage is abstracted, the hypervisor and virtual machines may not otherwise be able to determine the location of their data without the metadata.) The metadata may generally include any data regarding virtual machines and applications executing on the stretched cluster.

Communication between CMMDS and the management controller may occur via a plug-in in the HCI management system, a driver, or a software agent, which may be used for situations in which the management controller is in a different subnet.

Various factors may influence the decision of which management controller is selected to act as a witness node. For example, it may be advantageous for the witness management controller and the host components not to be in the same node. Further, a witness management controller may be established in both sites of the stretched cluster, to act redundantly and share the load.

As part of disk re-creation (in a failure scenario), if the new disk is created on a node where a witness management controller is present, then the witness may be automatically moved to another node where there is no component related to the host. CMMDS may orchestrate this movement to protect the cluster against a node failure.

According to some embodiments, there may be redundancy for the witness management controller. For example, a management controller in each site may act as a witness node. For each of these witness nodes, there may be an associated metadata object in the respective site, hence acting as a RAID 1 policy by default. The metadata redundancy policy may also be customized based on user requirements.

In the situation of a host failure or a site failure, embodiments may provide sufficient resiliency to continue operating. For example, consider the situation in which Site 1 goes down (e.g., due to a network or power failure). An object and its corresponding components that were created in Site 1 are also present at Site 2, per the RAID 1 (or other suitable redundancy) policy for the stretched cluster. All of the witness node(s) which were running on Site 1 hosts' management controllers are also fault-resilient. Thus for any given component, the replica of the same component is available running in Site 2, as well as its witness metadata. Thus at least 50% of the object components remain available even when there is a total site failure.

The same level of fault tolerance may also be applicable for less sever failures, such as host failure, disk failure, “split brain” situations, etc.

When an object's component rebuild/recreation is initiated, various actions may take place. For example, when a host's management controller fails and it was managing a set of the component's witness responsibilities, reliability will not be impacted due to the redundancies created for witness nodes and corresponding metadata. When a management controller fails, the secondary management controller becomes the primary witness point of contact. Meanwhile, CMMDS and the cluster management system may together select a new management controller to act as a secondary witness node and recreate the metadata as needed.

During a site failure, the redundant site and witness node may take over control to ensure the continuity of services. When an alternate site is identified to rebuild, CMMDS may rebuild the components from the active host and witness nodes based on the policy configured with the help of various components of the cluster management system such as a Cluster-Level Object Manager (CLOM), a Distributed Object Manager (DOM), and a Local Log Structured Object Manager (LSOM).

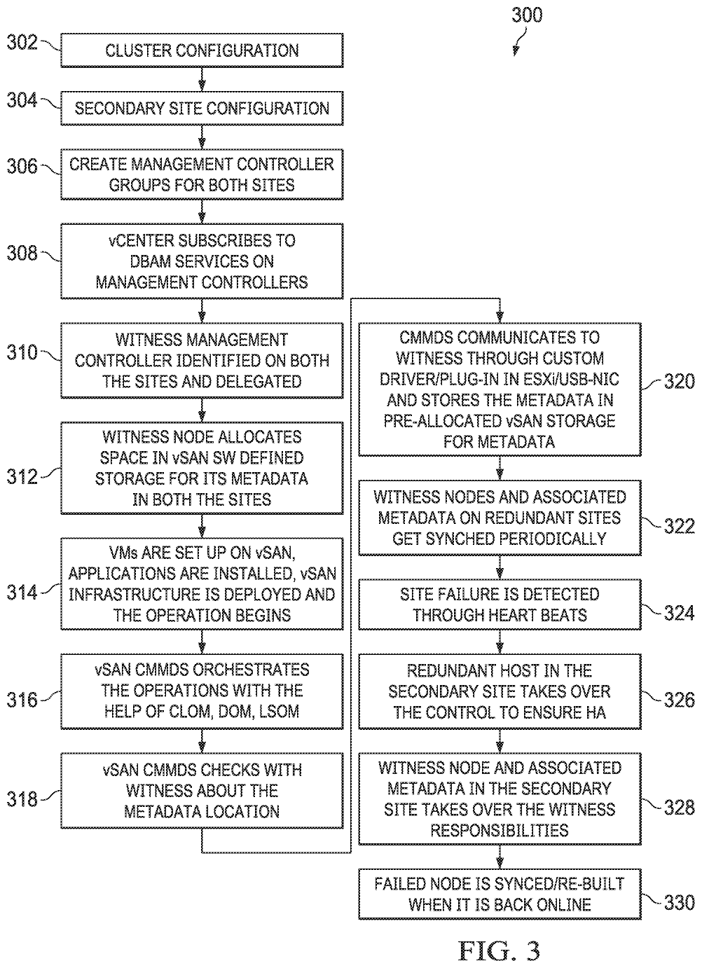

Turning now to FIG. 3, a flow chart is shown of an example method 300, in accordance with some embodiments of this disclosure.

At step 302, cluster configuration may take place (e.g., at a first site of a two-site stretched cluster). At step 304, the secondary site may be configured.

At step 306, a cluster management system (e.g., vCenter) may create management controller groups for both sites. At step 308, vCenter may subscribe to a service executing on the management controllers to receive updates regarding their bandwidth availability. At step 310, vCenter may identify a management controller at each site that is to serve as a witness node.

At step 312, each witness node may allocate space in software-defined storage for storage of its metadata. At step 314, virtual machines may be set up on the cluster, any desired applications may be installed, any desired infrastructure may be deployed, and the stretched cluster may begin normal operations. Operations may be orchestrated at step 316.

At step 318, a service such as CMMDS may query the witness node(s) regarding the metadata location. As noted at step 320, CMMDS may communicate with the witness nodes via a custom driver, a plug-in in ESXi, and/or a USB-NIC, and it may store metadata in the pre-allocated storage from step 312.

During normal operation, at step 322, witness nodes and their associated metadata may be periodically synchronized between the redundant sites.

Eventually a node or site may fail, and this may be detected via missing heart beats at step 324. At step 326, a redundant host in the secondary site may take over control of the stretched cluster to ensure high availability.

The witness node and its associated metadata in the secondary site may also take over the witness responsibilities at step 328. At step 330, the failed node may be synced/rebuilt when it comes back online.

One of ordinary skill in the art with the benefit of this disclosure will understand that the preferred initialization point for the method depicted in FIG. 3 and the order of the steps comprising that method may depend on the implementation chosen. In these and other embodiments, this method may be implemented as hardware, firmware, software, applications, functions, libraries, or other instructions. Further, although FIG. 3 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

Thus embodiments of this disclosure may provide numerous benefits. For example, there is no need for having a dedicated witness node in a separate site, as its responsibilities may be taken over by distributed management controllers. This may reduce the cost and complexities associated with having a dedicated witness node. Automatic fail-over when any of the hosts and/or witness nodes fail may be accomplished by having redundant witness nodes and associated metadata in the secondary site.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system cluster comprising:
a first site located at a first geographical location and comprising a set of first management controllers; and
a second site located at a second geographical location and comprising a set of second management controllers;
wherein the information handling system cluster is configured to provide software-defined storage based on physical storage resources at the first site and the second site;
wherein the information handling system cluster is further configured to execute a cluster management system configured to select individual ones of the set of first management controllers and the set of second management controllers to act as distributed witness nodes for the information handling system cluster.

2. The information handling system of claim 1, wherein the information handling system cluster is a hyper-converged infrastructure (HCI) cluster.

3. The information handling system of claim 1, wherein the distributed witness nodes are configured to store metadata regarding the software-defined storage in a pre-allocated portion of the software-defined storage.

4. The information handling system of claim 1, wherein the individual ones of the set of first management controllers and the set of second management controllers are selected to act as distributed witness nodes based at least in part on their available network bandwidth.

5. The information handling system of claim 4, wherein the cluster management system is further configured to subscribe to updates regarding the available network bandwidth of the set of first management controllers and the set of second management controllers.

6. The information handling system of claim 1, wherein, in response to a failure of one of the distributed witness nodes at the first site, a corresponding one of the distributed witness nodes at the second site is configured to replace the failed witness node.

7. The information handling system of claim 1, wherein each of the distributed witness nodes at the first site has a corresponding distributed witness node at the second site with redundant data.

8. A method comprising:
executing a cluster management system at an information handling system cluster that includes:
a first site located at a first geographical location and comprising a set of first management controllers; and
a second site located at a second geographical location and comprising a set of second management controllers;
wherein the information handling system cluster is configured to provide software-defined storage based on physical storage resources at the first site and the second site; and
wherein the cluster management system is configured to select individual ones of the set of first management controllers and the set of second management controllers to act as distributed witness nodes for the information handling system cluster.

9. The method of claim 8, wherein the information handling system cluster does not include a third site.

10. The method of claim 8, wherein the distributed witness nodes store metadata regarding the software-defined storage in a pre-allocated portion of the software-defined storage.

11. The method of claim 8, wherein the individual ones of the set of first management controllers and the set of second management controllers are selected to act as distributed witness nodes based at least in part on their available network bandwidth.

12. The method of claim 11, wherein the cluster management system is further configured to subscribe to updates regarding the available network bandwidth of the set of first management controllers and the set of second management controllers.

13. The method of claim 8, further comprising:
in response to a failure of one of the distributed witness nodes at the first site, replacing the failed witness node with a corresponding one of the distributed witness nodes at the second site.

14. The method of claim 8, wherein each of the distributed witness nodes at the first site has a corresponding distributed witness node at the second site with redundant data.

15. An article of manufacture comprising a non-transitory, computer-readable medium having computer-executable instructions thereon that are executable by a processor of an information handling system for:
executing a cluster management system at an information handling system cluster that includes:
a first site located at a first geographical location and comprising a set of first management controllers; and
a second site located at a second geographical location and comprising a set of second management controllers;
wherein the information handling system cluster is configured to provide software-defined storage based on physical storage resources at the first site and the second site; and
wherein the cluster management system is configured to select individual ones of the set of first management controllers and the set of second management controllers to act as distributed witness nodes for the information handling system cluster.

16. The article of claim 15, wherein the information handling system cluster is a hyper-converged infrastructure (HCI) cluster.

17. The article of claim 15, wherein the distributed witness nodes are configured to store metadata regarding the software-defined storage in a pre-allocated portion of the software-defined storage.

18. The article of claim 15, wherein the individual ones of the set of first management controllers and the set of second management controllers are selected to act as distributed witness nodes based at least in part on their available network bandwidth.

19. The article of claim 15, wherein, in response to a failure of one of the distributed witness nodes at the first site, a corresponding one of the distributed witness nodes at the second site is configured to replace the failed witness node.

20. The article of claim 15, wherein each of the distributed witness nodes at the first site has a corresponding distributed witness node at the second site with redundant data.
